(19) United States
(12) Patent Application Publication
(10) Pub. No.: US 2007/0209179 A1
(43) Pub. Date: Sep. 13, 2007

(54) Lathe hobbing tool

(76) Inventors: Mark Williams, Louisville, CO (US); Bret Goethe, Louisville, CO (US)

Correspondence Address: Harbin King & Klima, 500 Ninth Street SE, Washington, DC, 20003, US

(21) Appl. No.: 11/405,009

(22) Filed: Apr. 17, 2006

Related U.S. Application Data
(60) Provisional application No. 60/671,521, filed on Apr. 15, 2005.

(51) Int. Cl. B23B 27/00

(52) U.S. Cl. 29/27 C; 29/40

(57) ABSTRACT

A hobbing tool connects to a CNC lathe for performing a hobbing operation on a workpiece mounted in the lathe. It includes a drive end for mounting to a tool station of a turret of the lathe and for being driven by the lathe and a hobbing end having a hob drive shaft for supporting and driving a hob to machine a portion of the workpiece mounted in the lathe. The hob drive shaft is operatively connected to the drive end so that the hob drive shaft can be rotationally driven by the lathe. The hobbing end is connected to the drive end with a rotationally adjustable coupling which allows a lead angle of the hob shaft to be adjusted with respect to the workpiece.

This application claims priority to U.S. Provisional Patent Application 60/671,521, filed Apr. 15, 2005, entitled Lathe Hobbing Tool and by the same inventors as the present application, the entirety of which provisional application is incorporated by reference herein.

### BACKGROUND OF THE INVENTION

The present invention relates to a tool for use with a lathe that can perform hobbing on a workpiece mounted in the lathe.

Hobbing is a well known process for creating gear teeth and/or splines on a component (workpiece). This is done in a hobbing machine which uses interchangeable hobs to cut the teeth into components. Hobbing machines are complex machines that provide for numerous adjustments to accommodate different sizes of workpieces, different sizes of hobs, different pitches of teeth, etc. Hobbing is an effective, efficient process for creating strong, precisely formed and positioned teeth on a workpiece. The hob is essentially a cutting tool generally in the form of a thread and rotates about an axis set at a lead angle to an axis of the workpiece, dependent on the pitch of the teeth/splines to be cut. The workpiece is rotated at a precise rate which depends on the hob being used and the diameter of the workpiece and the rotating hob (also rotating at a rate depending on the hob being used and the diameter of the workpiece) is brought into contact with the workpiece rotating about its own axis. The rotating hob is fed into the rotating workpiece in one or more passes until the teeth/splines are completely formed.

Many hobbing machines are completely mechanically controlled and the different rotating rates are set by, for instance, changing drive paths through drive gearboxes of the machine. Some hobbing machines now use computer numerical control (CNC) to vary the parameters of the hobbing operation.

Lathes, and especially CNC lathes, are commonly used in production environments for creating turned items. CNC lathes usually include turrets holding several indexable tools so that once a workpiece is chucked in the lathe, several, if not all, of the machining operations can be performed on the workpiece before it is removed from the lathe. This increases the production rate of the components and can decrease errors in machining, such as can be caused when transferring the workpiece from one machine to another.

Previously, it has not been possible to perform a hobbing operation on a 3-axis CNC lathe, and turned items from the lathe that included toothed/splined portions, such as drive shafts and drive axles, had to be removed from the lathe and set-up in a hobbing machine to cut the toothed/splined portions. As noted above, this is inefficient, decreases productivity and increases the possibility of error in cutting the toothed/splined portions.

### SUMMARY OF THE INVENTION

The present invention is a hobbing tool that connects to a CNC lathe for performing a hobbing operation on a workpiece mounted in the lathe. It includes a drive end for mounting to a tool station of a turret of the lathe and for being driven by the lathe and a hobbing end having a hob drive shaft for supporting and driving a hob to machine a portion of the workpiece mounted in the lathe. The hob drive shaft is operatively connected to the drive end so that the hob drive shaft can be rotationally driven by the lathe. The bobbing end is connected to the drive end with a rotationally adjustable coupling which allows a lead angle of the hob shaft to be adjusted with respect to the workpiece.

In a method according to the present invention, a hobbing operation is performed on a workpiece mounted in a lathe and includes mounting a hob on a hob drive shaft of a lathe hobbing tool. The lathe hobbing tool is mounted on a driven turret station of the lathe so that the hob is rotationally driven by the lathe. A lead angle of the hob with respect to the workpiece is rotationally adjusted. A rotational speed of the hob drive shaft is synchronized to a rotational speed of the workpiece based on the workpiece and the bob being used to machine the workpiece. The turret is moved to bring the rotating hob into machining engagement with the rotating workpiece and this step is repeated if necessary to progressively hob the workpiece.

Advantages of the present invention will be apparent from the description herein.

### DESCRIPTION OF THE DRAWINGS

FIG. 1 is a side view of a hobbing tool for of the present invention for use with a lathe, viewed from a hob side of the tool;

FIG. 2 is a partial sectional view of the hobbing tool of FIG. 1, taken along sectional line 2-2 of FIG. 1;

FIG. 3 is a side view of the hobbing tool of FIG. 1, viewed along an axis if the hob;

FIG. 4 is a partial sectional view of the hobbing tool of FIG. 1, taken along sectional line 4-4 of FIG. 3;

FIG. 5 is a perspective view of the hobbing tool of FIG. 1;

FIG. 6 is a further perspective view of the hobbing tool of FIG. 1;

FIG. 7 is a perspective view of the hobbing tool of FIG. 1 installed in a lathe turret to cut splines on a workpiece chucked in the lathe;

FIG. 8 is an enlarged view of the hobbing tool of FIG. 7 from a different perspective; and

FIG. 9 is a schematic view of one embodiment of a controller for a lathe using the hobbing tool of the present invention.

### DETAILED DESCRIPTION

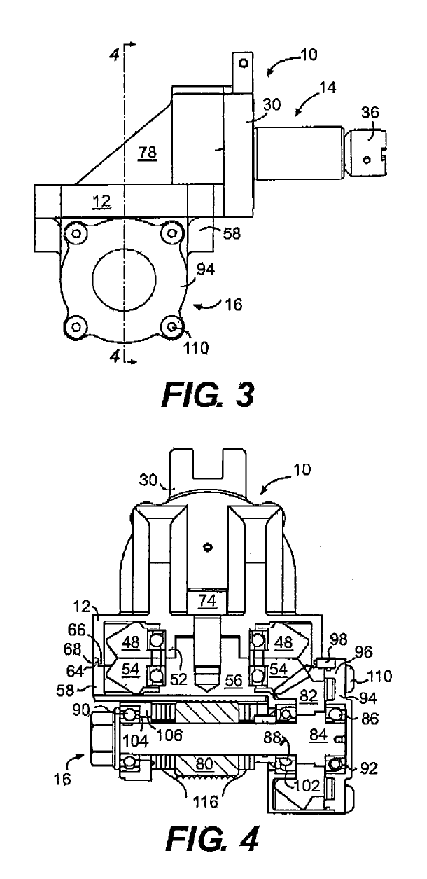

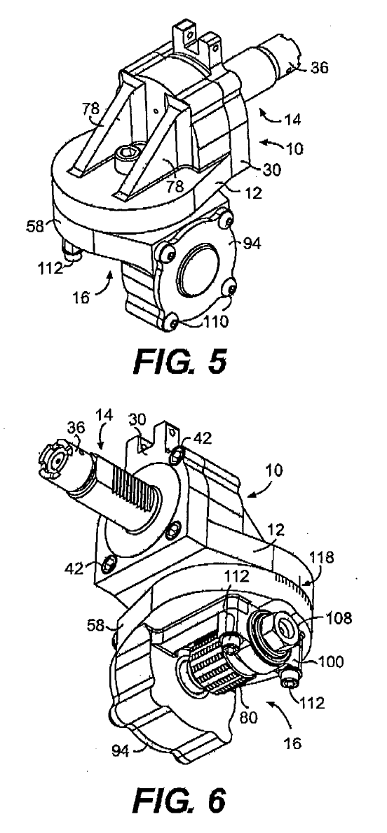

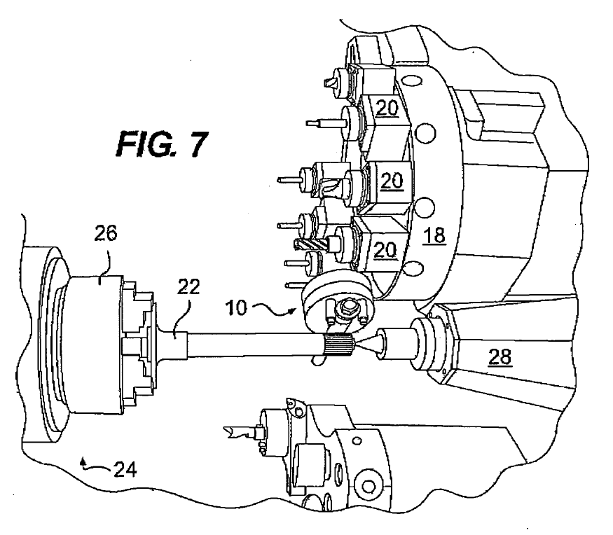

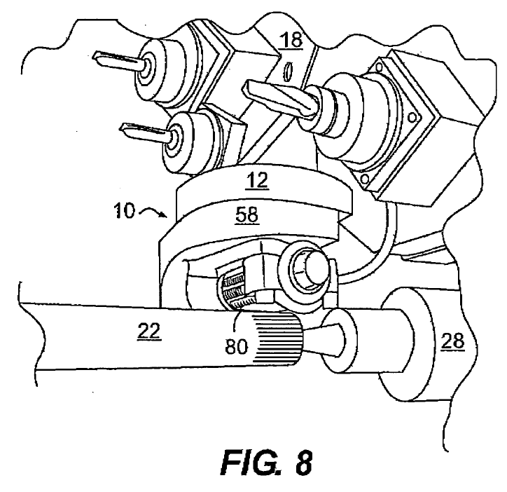

The lathe hobbing tool 10 of the present invention is shown in FIGS. 1-8. It includes a main housing 12 to which is connected a drive end 14 for mounting to a tool station 20 of a lathe turret 18 in a known manner. The lathe turret 18 includes a number of tool stations 20 for receiving both live and stationary tools and also includes an internal drive system for driving live tools. Rotation of the turret 18 allows a desired one of the number of tools mounted at the tool stations to be indexed for a machining operation on a workpiece 22 mounted in lathe 24 (see FIGS. 7-8). On the lathe 24 shown, the workpiece is mounted between chuck 26 and tailstock 28. The chuck 26 is connected to the lathe's drive system for driving (rotating) the workpiece 22 in a known manner.

The drive end 14 includes a drive housing 30. The drive housing includes a flange 38 for mounting in a bore 40 of the main housing 12. The flange accurately positions the drive end 14 in the main housing 12. A plurality of bolts 42 (FIG. 6) engage threaded bores in the main housing 12 to securely fasten the drive end 14 to the main housing 12. A drive shaft 32 is rotationally supported in a bore 34 of the housing and includes a drive coupling 36 for coupling to the internal drive system of the lathe turret 18 in a known manner. The drive end 14 is shown in a standard VDI-40 configuration but can also be constructed in alternative configurations to be mounted in alternative styles of lathe turrets, as well as to have alternative drives, including its own dedicated drive system.

A first bevel gear 44 is attached to the drive shaft 32 in a known manner to be rotationally driven by the drive coupling 36. The drive shaft 32 and bevel gear 44 is rotationally supported in the drive housing 30 by two roller bearings 46, although alternative types of bearings or bearing surfaces can also be used here and where other roller bearings discussed below are used. First bevel gear 44 drivingly engages a second bevel gear 48 which is rotationally supported in the main housing 12 by roller bearing 50 mounted on a boss 52 of main housing 12. In this manner, the rotational drive about an axis of drive shaft 32 can become a rotational drive about an axis of second bevel gear 48. Here the two axes are at an angle of 90° to one another, although different angles can be used where appropriate.

A third bevel gear 54 is securely attached to second bevel gear 48 by a known method so that second bevel gear 48 and third bevel gear 54 move in unison. The two bevel gears can be attached to one another by pins, teeth/splines, threaded fasteners, welding or in other manners. Alternatively, the two gears can be constructed as a single component with the two driving gear faces provided on opposite sides of the same component.

The hobbing end 16 includes a hob housing 58 which includes a boss 56. Third bevel gear 54 is rotationally supported on the boss 56 of the hob housing 58 by roller bearing 60. The boss 56 includes a centering portion 62 which engages a bore 64 of boss 52 to provide accurate positioning of the hobbing end 16 with respect to the main housing 12. The hob housing 58 also includes a flange 64 which can engage a flange 66 of main housing 12 to provide further positioning support between the hobbing end 16 and the main housing 12. The positioning support can be provided by the bosses, the flanges or both. A seal, o-ring or gasket 68 is provided between the hob housing 58 and the main housing 12 to provide an oil-tight seal between the two housings. A seal, o-ring or gasket 70 can also be provided between the drive housing 30 and the main housing 12 to provide an oil-tight seal. Although the two bevel gears 48 and 54 are shown as being rotationally supported on the bosses 52 and 56, respectively, in an alternative embodiment, either of the bosses can be extended (and the other shortened), so that both bevel gears are rotationally supported on only one of the bosses.

The boss 56 includes a threaded bore 72 for receiving a lead angle adjustment bolt 74, or other threaded fastener, that passes through bore 76 in main housing 12. The bolt 74 can be tightened to clamp the hobbing end 16 in a fixed position relative to the main housing 12. The bolt 74 can be loosened to allow the hobbing end 16 to be rotated with respect to the main housing 12 to adjust the hobbing tool 10 to the lead angle of the hob 80 to be used. This is important since the lead angle is dependent upon the pitch of the teeth/splines to be cut and changing to a hob 80 having a different pitch requires adjusting the lead angle. A fixed lead angle arrangement would only work for hobs cutting one pitch of teeth/splines. In the embodiment shown, the hobbing end 16 can be rotated a full 360° with respect to the main housing 12, although only a fraction of this range is required for the majority of hobbing operations. Ribs 78 on the main housing 12 strengthen the main housing 12 while allowing easy access to the lead angle adjustment bolt 74.

The third bevel gear 54 drivingly engages a fourth bevel gear 82 attached to a hob drive shaft 84. See FIG. 4. In this manner, the rotational drive about an axis of third bevel gear 54 can become a rotational drive about an axis of fourth bevel gear 82 and hob drive shaft 84. Here the two axes are at an angle of 90° to one another, although different angles can be used where appropriate. Hob drive shaft 84 is rotationally supported by roller bearings 86, 88 and 90. Roller bearing 86 is supported in a bore 92 of an access cover 94 of hob housing 58. In addition to supporting the roller bearing 86, the access cover 94 allows access to the fourth bevel gear 82, the hob drive shaft 84 and the roller bearings 86 and 88. Access cover 94 includes a flange 96 which engages a flange 98 of hob housing 58 to accurately position the access cover 94 with respect to the hob housing 58. A seal, o-ring or gasket 100 is positioned between the flange 96 and the flange 98 to provide an oil-tight seal. Bolts 110 secure the access cover 94 to the hob housing 58.

Roller bearing 88 is supported in bore 102 of hob housing 58. The bearing 88 can be a sealed type bearing to maintain an oil-tight seal (as can other bearings described herein) and/or an additional seal can be provided outboard of the roller bearing 88. Roller bearing 90 is supported in bore 104 of boss 106 of hob housing 58. A nut or other threaded fastener 108 is threaded onto the free end of drive shaft 84 to maintain the drive shaft 84 in the correct position.

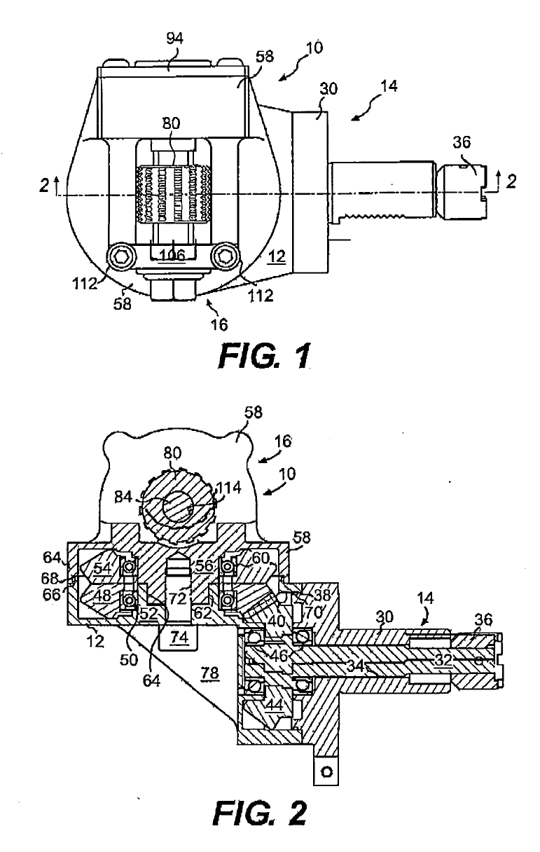

Boss 106 is secured to the hob housing 58 by bolts 112 and is removable from the hob housing 58 by removing the bolts 112 and the nut 108 and sliding the boss 106 and roller bearing 90 off the end of the drive shaft 84. In this same manner, the hob 80 can be readily slid off/on the drive shaft 84 to change the hob 80 without accessing the interior of the hobbing tool 10. The hob 80 is rotationally secured to the drive shaft 84 by key 114 (FIG. 2). In a preferred embodiment, hob 80 is a readily available, industry standard hob offered in a wide range of tooth/spline cutting sizes. The length of the drive shaft 84 is set as desired to provide sufficient axial free space to accommodate a wide range of hobs. Shim washers 116 can be positioned on one or both sides of the hob 80 to remove excess axial clearance, as well as to reposition the hob 80 to equalize cutting edge wear and extend the life of the hob 80. Likewise, the drive shaft is radially spaced away from the adjacent portion of the hob housing 58 to also accommodate a wide range of standard hobs 80. Appropriate lubricant is provided in the interior of the sealed hobbing tool 10 to lubricate the internal moving components.

The operation of the hobbing tool 10 will now be explained. See especially, FIGS. 7-8. The hobbing tool 10 is mounted in a live tool station 20 of the turret 18. Hob 80 can be installed prior to installing the hobbing tool 10 on the turret 18 or after, as described above. The turret live tool drive system drives drive coupling 36, drive shaft 32 and first bevel gear 44, which in turn, drives second and third bevel gears 48 and 54. Third bevel gear 54 drives fourth bevel gear 82, hob drive shaft 84 and hob 80 (with key 114). Although the main housing 12 is fixed to the turret 18 when the hobbing tool 10 is attached to the turret 18, the hob housing 58 can be rotated with respect to the main housing 12 by loosening the lead angle adjustment bolt 74 to adjust for the lead angle of the hob 80 and set the hob 80 to the proper angle with respect to the workpiece 22. The lead angle adjustment bolt 74 is then tightened to rotationally lock the hob housing 58 to the main housing 12. A vernier or other scale 118 can be provided on the main housing 12 and hob housing 58 to assist in adjusting for the lead angle.

Alternative gear and/or drive systems can be used as long as they provide for the adjustment of the lead angle of the hob 80 while driving the hob 80 about the adjusted hob axis. In a preferred embodiment, the live tool drive system of the lathe turret will be used to reduce the cost of the lathe hobbing tool 10. In such a case, the hobbing tool 10 must generally be capable of driving the hob 80 about an axis that lies in a plane that is parallel to an axis about which the turret drives the live tool and the axis of the hob must be adjustable in such plane.

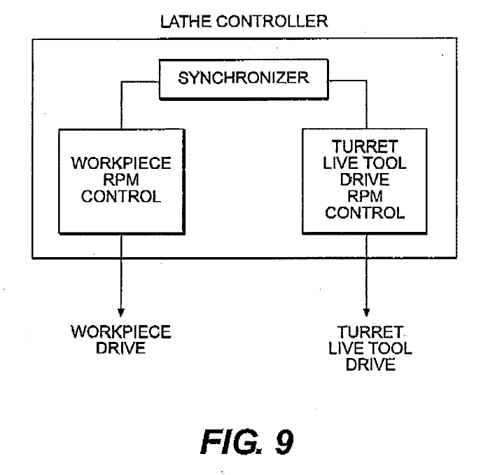

The rotation speed of the hob 80 with respect to the workpiece 22 must be determined based on the diameter of the workpiece and the pitch of the teeth/splines to be cut so that the hob 80 is driven in complete synchronization with the workpiece 22. The rotation speed of the workpiece 22 is readily set with a CNC lathe for precise rotation of the workpiece 22. However, in a standard 3-axis turret lathe, the speed of the live tool drive cannot be synchronized with the speed of the workpiece. Therefore, the lathe controller is preferably modified so that the workpiece speed and the hob speed can be completely synchronized with respect to one another based on the desired parameters for the hobbing operation. An embodiment of such a controller is shown in FIG. 9, where the turret live tool drive rpm can be controlled as desired and synchronized with the workpiece rpm control. Portions of the lathe controller not necessary for explanation of the present invention have been omitted. Alternative controls and control arrangements can also be used.

The turret 18 can be moved along two axes to position the hob 80 with respect to the workpiece 22: the x-axis to adjust radially with respect to the workpiece 22 and the z-axis to adjust along the axial length of the workpiece 22. Depending on the size of the workpiece and the depth of the teeth/splines to be cut, an appropriate number of axial passes will be determined and programmed into the lathe controller. The hob 80 will be moved to the first radial depth for the first axial pass outboard of the tail end of the workpiece 22 and then axially moved along the workpiece 22 until the desired axial length of cut is achieved. The hob 80 will then be returned to the starting position, reset for a new radial depth and again axially moved along the workpiece 22 to the desired axial length of cut. This is repeated until the desired depth of teeth/splines is reached. Alternatively, the hob 80 can be repositioned radially inward for each forward and return axial pass.

Several of the above steps can be performed in an alternative order and can also be performed manually. In the preferred embodiment, once the original set-up is accomplished, the hobbing operation will be performed automatically by the CNC lathe as just one of a series of operations the CNC lathe performs automatically on the workpiece 22. A separate hobbing machine is not required and the workpiece need not be removed from the lathe and set up in a separate machine, reducing set-up time, the possibility of errors due to transferring the workpiece from one machine to another, and scrap rate, while increasing production rate. The hobbing too is merely set up in one station of the lathe turret, as with other tools.

The present invention can be used for many types of hobbing operations on a lathe, including, but not limited to, for instance, the cutting of splines on the end of a drive shaft or drive axle.

What is claimed is:

1. A hobbing tool for connection to a CNC lathe for performing a hobbing operation on a workpiece mounted in the lathe, comprising:
a drive end for mounting to a tool station of a turret of the lathe and for being driven by the lathe; and
a hobbing end having a hob drive shaft for supporting and driving a hob to machine a portion of the workpiece mounted in the lathe, the hob drive shaft operatively connected to the drive end so that the hob drive shaft can be rotationally driven by the lathe; the hobbing end being connected to the drive end with a rotationally adjustable coupling which allows a lead angle of the hob shaft to be adjusted with respect to the workpiece.

2. The hobbing tool of claim 1, wherein the hobbing end further comprises:
a hob housing which is adjustably rotationally mounted with respect to the drive end;
a portion for maintaining a concentricity of the hob housing about a hob housing rotational axis as the hob housing is rotationally adjusted; and
a releasable fixing mechanism for releasably fixing the rotational adjustment of the hob housing.

3. The hobbing tool of claim 2, wherein the portion for maintaining a concentricity of the hob housing comprises a circular boss portion centered on the hob housing rotational axis received and positioned in a circular bore also centered on the hob housing rotational axis.

4. The hobbing tool of claim 3, wherein the releasable fixing mechanism comprises a threaded fastener connected to the hob housing for clamping the hob housing to a further portion of the hobbing tool when the treaded fastener is tightened.

5. The hobbing tool of claim 4, wherein a bevel gear is attached to the hob drive shaft for driving the hob drive shaft, the hob drive shaft bevel gear engaging and being driven by a further bevel gear, the further bevel gear rotating about the hob housing axis of rotation that is normal to an axis of rotation of the hob drive shaft and hob drive shaft bevel gear, the hob drive shaft bevel gear indexing around the further bevel gear, and rotating the hob drive shaft, when the hob housing is rotationally adjusted to adjust a lead angle of the hob drive shaft.

6. The hobbing tool of claim 5, wherein the further bevel gear is drivingly attached to a backing bevel gear, the further and backing bevel gears having toothed portions facing away from one another, the further and backing bevel gears both rotating about the hob housing axis of rotation, the backing bevel gear engaging with and being driven by a drive end bevel gear attached to a drive end drive shaft drivingly connected to the lathe.

7. The hobbing tool of claim 6, wherein an axis of rotation of the drive end drive shaft and drive end bevel gear is normal to the hob housing axis of rotation.

8. The hobbing tool of claim 7, wherein one end of the hob drive shaft is releasably rotationally mounted to the hob housing by a carrier boss, with removal of the carrier boss from the hob drive shaft allowing access to that end of the hob drive shaft to replace the hob driven by the drive shaft.

9. The hobbing tool of claim 8, and further comprising a synchronizer for synchronizing a rotational speed of the hob drive shaft to a rotational speed of the workpiece based on the workpiece and the hob being used to machine the workpiece.

10. The hobbing tool of claim 9, wherein the synchronizer is included in a controller for the lathe.

11. The hobbing tool of claim 1, and further comprising a synchronizer for synchronizing a rotational speed of the hob drive shaft to a rotational speed of the workpiece based on the workpiece and the hob being used to machine the workpiece.

12. The hobbing tool of claim 11, wherein the synchronizer is included in a controller for the lathe.

13. The hobbing tool of claim 2, wherein one end of the hob drive shaft is releasably rotationally mounted to the hob housing by a carrier boss, with removal of the carrier boss from the hob drive shaft allowing access to that end of the hob drive shaft to replace the hob driven by the drive shaft.

14. A method of performing a hobbing operation on a workpiece mounted in a lathe, comprising:
mounting a hob on a hob drive shaft of a lathe hobbing tool;
mounting the lathe hobbing tool on a driven turret station of the lathe so that the hob is rotationally driven by the lathe;
rotationally adjusting a lead angle of the hob with respect to the workpiece;
synchronizing a rotational speed of the hob drive shaft to a rotational speed of the workpiece based on the workpiece and the hob being used to machine the workpiece; and
moving the turret to bring the rotating hob into machining engagement with the rotating workpiece.

15. The method of claim 14 and further comprising; repeating the step of moving the turret into machining engagement with the rotating workpiece, wherein each subsequent step moves the turret further with respect to the workpiece to progressively hob the workpiece.

16. The method of claim 15, wherein the synchronizing step is performed by a controller of the lathe.
